(19) United States
(12) Patent Application Publication
(10) Pub. No.: US 2024/0220875 A1
(43) Pub. Date: Jul. 4, 2024

(54) AUGMENTING ROLES WITH METADATA

(71) Applicant: INTERNATIONAL BUSINESS MACHINES CORPORATION, Armonk, NY (US)

(72) Inventors: Madhusmita Patil, Hyderabad (IN); Vivek Warrier, Bengaluru (IN); Renjith Koorumullamkattil Mathew, Bangalore (IN); Parag Sanjay Mhatre, Pen (IN); Karanam Rakesh, Eluru (IN); Ayushi Jain, Indore (IN); Swati Anand, Noida (IN)

(21) Appl. No.: 18/148,988

(22) Filed: Dec. 30, 2022

(51) Int. Cl. G06Q 10/063; G06F 40/40

(52) U.S. Cl. CPC G06Q 10/063; G06F 40/40

(57) ABSTRACT

A computer hardware system includes a machine learning engine and a hardware processor configured to perform the following executable operations. Text of a role description of a role having a role title is preprocessed. Competencies are inferred from the role description; using the machine learning engine. Competencies are identified from titles in a talent framework being similar to the title using the machine learning engine. The competencies are aggregated into an aggregation of competencies. The competencies in the aggregation are ordered based upon aggregated similarity scores. A proficiency level associated with each of the competencies in the aggregation is adjusted based upon band level and competency type. A plurality of competencies are selected. The role is augmented with metadata that includes the selected plurality of competencies and proficiency levels associated therewith.

### BACKGROUND

The present invention relates to machine learning, and more specifically, to augmenting roles with metadata identified using machine learning.

A competencies are skills and/or qualities that an employee needs to have in order to succeed in their role. Managers use competencies to give feedback, have development conversations, and delegate tasks. Interviewers also use competencies—and interviewers use them to assess job-fit. Job competencies (hereinafter “competencies”) can include functional competencies (e.g., measurable technical skills such as certifications) and foundational skills (e.g., soft skills such as team building, management, etc.). Traditionally, role descriptions typically involve a job summary along with responsibilities, qualifications, and experience details. However, these traditional role descriptions to do include a list of competencies associated with a particular role.

### SUMMARY

A computer-implemented process within a computer hardware system having a machine learning engine includes the following executable operations. Text of a role description of a role having a role title is preprocessed. Competencies are inferred from the role description; using the machine learning engine. Competencies are identified from titles in a talent framework being similar to the title using the machine learning engine. The competencies are aggregated into an aggregation of competencies. The competencies in the aggregation are ordered based upon aggregated similarity scores. A proficiency level associated with each of the competencies in the aggregation is adjusted based upon band level and competency type. A plurality of competencies are selected. The role is augmented with metadata that includes the selected plurality of competencies and proficiency levels associated therewith.

In further aspects of the process, the competencies include functional competencies and foundational competencies, and the selecting the competencies includes selecting, for a particular family, a predetermined number of foundational competencies and a predetermined number of functional competencies. The inferring the competences from the role description includes mapping the text of the role description to classes, filtering the text of the role description based upon the mapping, converting the text of the role description to a vector representation, and performing a similarity analysis using the vector representation to determine one or more competencies that correspond to the role description. The similarity analysis can employ a cosine similarity analysis for vectors A and B wherein the vector A represents the text of the role description and the vector B represents a particular competency. Preferred competencies can be extracted using the machine learning engine from the text of the role description. A prioritization of the competencies in the aggregation can be performed based upon source, where the competencies from the extracting the preferred competencies having a higher priority than the competencies from the inferring the competencies from the role description, the competencies from identifying the competencies from the titles in the talent framework having a lower priority from the inferring the competencies from the role description, and the selecting the plurality of competencies is based upon the prioritization. The preprocessing the text of a role description can include removing, using natural language processing, organization text, and standardizing the role title.

A computer hardware system includes a machine learning engine and a hardware processor configured to perform the following executable operations. Text of a role description of a role having a role title is preprocessed. Competencies are inferred from the role description; using the machine learning engine. Competencies are identified from titles in a talent framework being similar to the title using the machine learning engine. The competencies are aggregated into an aggregation of competencies. The competencies in the aggregation are ordered based upon aggregated similarity scores. A proficiency level associated with each of the competencies in the aggregation is adjusted based upon band level and competency type. A plurality of competencies are selected. The role is augmented with metadata that includes the selected plurality of competencies and proficiency levels associated therewith.

In further aspects of the system, the competencies include functional competencies and foundational competencies, and the selecting the competencies includes selecting, for a particular family, a predetermined number of foundational competencies and a predetermined number of functional competencies. The inferring the competences from the role description includes mapping the text of the role description to classes, filtering the text of the role description based upon the mapping, converting the text of the role description to a vector representation, and performing a similarity analysis using the vector representation to determine one or more competencies that correspond to the role description. The similarity analysis can employ a cosine similarity analysis for vectors A and B wherein the vector A represents the text of the role description and the vector B represents a particular competency. Preferred competencies can be extracted using the machine learning engine from the text of the role description. A prioritization of the competencies in the aggregation can be performed based upon source, where the competencies from the extracting the preferred competencies having a higher priority than the competencies from the inferring the competencies from the role description, the competencies from identifying the competencies from the titles in the talent framework having a lower priority from the inferring the competencies from the role description, and the selecting the plurality of competencies is based upon the prioritization. The preprocessing the text of a role description can include removing, using natural language processing, organization text, and standardizing the role title.

A computer program product includes computer readable storage medium having stored therein program code. The program code, which when executed by a computer hardware system including a machine learning engine, cause the computer hardware system to perform the following operations. Text of a role description of a role having a role title is preprocessed. Competencies are inferred from the role description; using the machine learning engine. Competencies are identified from titles in a talent framework being similar to the title using the machine learning engine. The competencies are aggregated into an aggregation of competencies. The competencies in the aggregation are ordered based upon aggregated similarity scores. A proficiency level associated with each of the competencies in the aggregation is adjusted based upon band level and competency type. A plurality of competencies are selected. The role is augmented with metadata that includes the selected plurality of competencies and proficiency levels associated therewith.

In further aspects of the computer program product, the competencies include functional competencies and foundational competencies, and the selecting the competencies includes selecting, for a particular family, a predetermined number of foundational competencies and a predetermined number of functional competencies. The inferring the competences from the role description includes mapping the text of the role description to classes, filtering the text of the role description based upon the mapping, converting the text of the role description to a vector representation, and performing a similarity analysis using the vector representation to determine one or more competencies that correspond to the role description. The similarity analysis can employ a cosine similarity analysis for vectors A and B wherein the vector A represents the text of the role description and the vector B represents a particular competency. Preferred competencies can be extracted using the machine learning engine from the text of the role description. A prioritization of the competencies in the aggregation can be performed based upon source, where the competencies from the extracting the preferred competencies having a higher priority than the competencies from the inferring the competencies from the role description, the competencies from identifying the competencies from the titles in the talent framework having a lower priority from the inferring the competencies from the role description, and the selecting the plurality of competencies is based upon the prioritization. The preprocessing the text of a role description can include removing, using natural language processing, organization text, and standardizing the role title.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

FIG. 1 is a block diagram illustrating an architecture of a role augmentation system and associated methodology according to an embodiment of the present invention.

FIG. 2 illustrates a similarity matrix according to an embodiment of the present invention.

FIG. 3 is a block diagram illustrating an example of computer environment for implementing portions of the methodology of FIG. 1.

### DETAILED DESCRIPTION

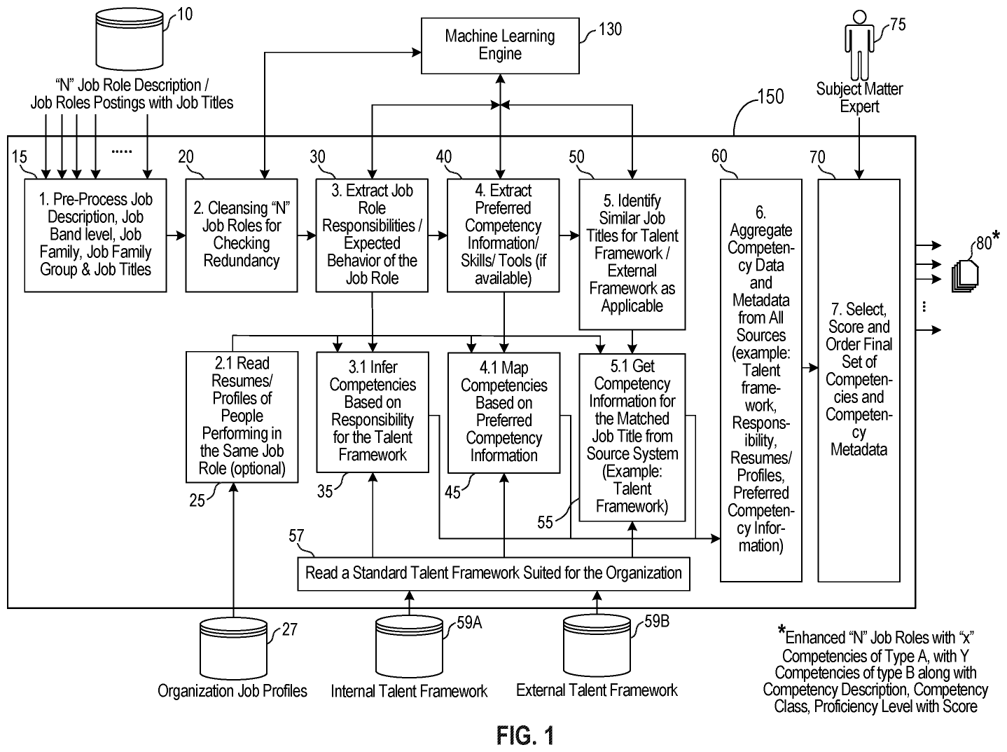

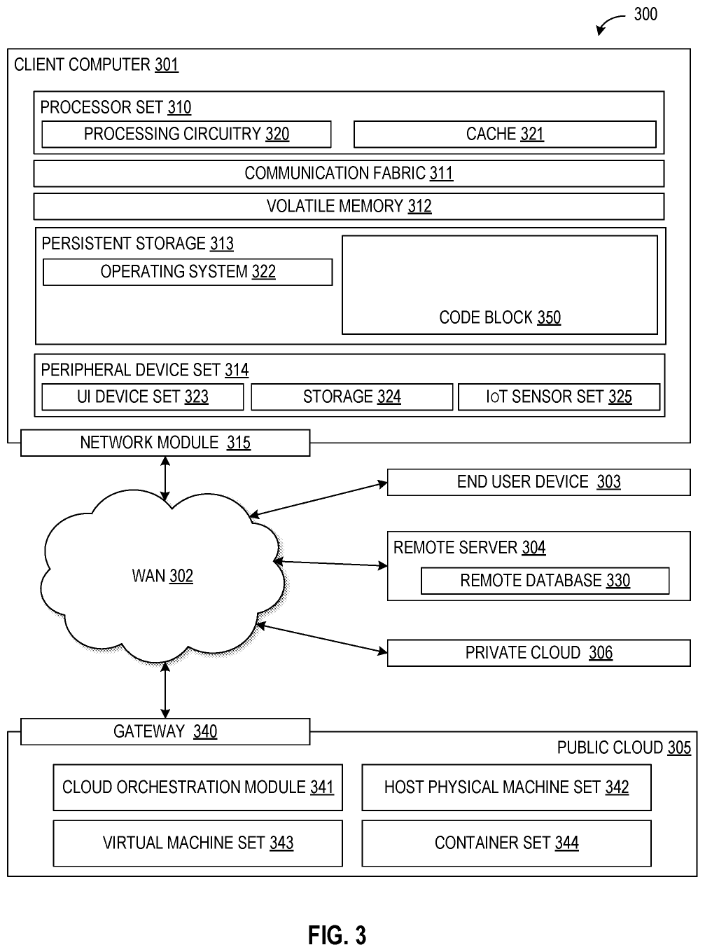

Reference is made to FIG. 1 which illustrates a role augmentation system 150 and associated methodology 100. Although not limited in this manner, the role augmentation system 150 can include and/or be connected to role repository 10, a machine learning engine 130, organization job profiles 27, and talent frameworks 59A-B. Although not limited in this manner, the machine learning engine 130 can be a neural network that includes natural language processing capabilities. Although illustrated as being within a single system 150, the individual components of the role augmentation system 150 can be distributed over a plurality of computer devices. Additionally, the machine learning engine 170 could be within a standalone computer system (not shown) or located in a cloud computing system such as described in FIG. 3.

Referring to block 15, the process 100 begins with the receipt of job roles (hereinafter referred to as “roles”) having job role titles (hereinafter referred to as “role titles”) and job role descriptions (hereinafter referred to as “role descriptions”) from a role repository 10. The role descriptions and role titles can then be preprocessing using natural language processing. This preprocessing can involve stripping out organizational text (e.g., “About us” and “Our Culture”) as well as standardizing the role titles such as removing locations and non-job role-related text.

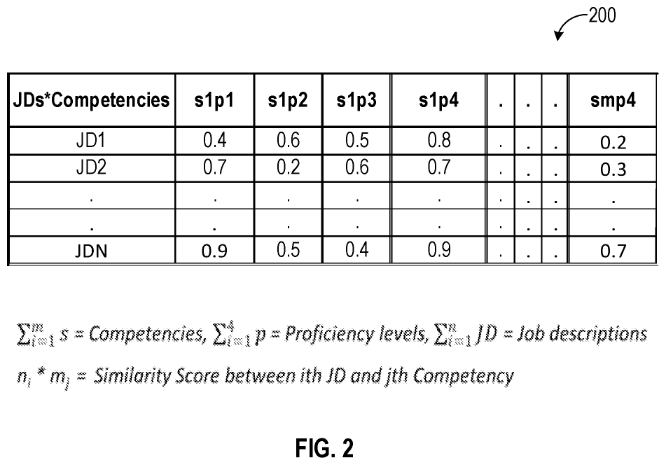

Referring to block 20, these redundant/duplicate/similar role descriptions are cleansed as the job repository 27 of organization job profiles frequently contains duplicate or similar role descriptions. This deduplication process can include, in block 25, reading the employee-relate documents such as resumes, projects assessments, and/or profiles of people performing in the same role for role descriptions. Referring to FIG. 2, a similarity matrix 200 can be generated. Although not limited in this manner, the similarity matrix (N*M) can be generated where N=number of role descriptions and M=number of competencies.

Referring to block 30, a machine learning engine is configured to extract role responsibilities and/or expected behaviors of roles from the role descriptions. Although not limited in this manner, the machine learning engine can map the sentences of the role description to classes, which can filter out extraneous information such that only information that is relevant to the job profile and competencies are considered. Examples of such classes include: job summary, job qualifications, job responsibilities, hard skills, and software skills. In certain aspects, a bi-directional long shot-term memory (BiLSTM) was trained using GloVe embeddings to classify the sentences of the role descriptions.

Referring to block 35, competencies are inferred from the role responsibilities identified in block 30. In certain aspects, the machine learning engine employs custom word embeddings and sentence embeddings to convert the text into a vector representation of the text. In certain aspects, the embedding technique used is based upon the context of the text to provide better representation of the text. Accordingly, multiple word embedding and sentence embedding models can be integrated together to convert the text into vector representation. Examples of these embedding techniques include Bidirectional Encoder Representations from Transformers (BERT) Sentence embeddings, Universal sentence encoder, Word Moving Distance, term frequency-inverse document frequency (TFDIF), and Fasttext. Once the vector representations of the text are generated, semantic and syntactic similarity can be calculated using, for example, any appropriate technique, such as cosine similarity, Euclidian distance, Jaccard distance, and word mover's distance. In certain aspects, however, cosine similarity is used to determine text similarity. The algorithm for determining cosine similarity for two vectors A and B is as follows:

$$similarity = cos ( θ ) = \frac{A \cdot B}{‖ A ‖ ‖ B ‖} = \frac{{\sum }_{i = 1}^{n} {A}_{i} {B}_{i}}{\sqrt{{\sum }_{i = 1}^{n} {A}_{i}^{2}} \sqrt{{\sum }_{i = 1}^{n} {B}_{i}^{2}}} ,$$

where Aᵢ and Bᵢ are components of vector A and B respectively.

In this instance, vector A represents the text of the role description and vector B represents a particular competency. Based upon the determined value of similarity, one or more competencies are selected as corresponding to the role description.

Referring to block 40, the machine learning engine is configured to extract preferred competencies (if available) from the text. Although not limited in this manner, the machine learning engine can mapping the sentences of the role description to classes, which can filter out extraneous information such that only information that is relevant to the profile and its competencies are considered. Examples of such classes include: job summary, job qualifications, job responsibilities, hard skills, and software skills. In certain aspects, a bi-directional long shot-term memory (BiLSTM) was trained using GloVe embeddings to classify the sentences of the role descriptions.

Referring to block 45, preferred competencies are inferred from the role responsibilities identified in block 40. In many instances, few role descriptions contain information about preferred competencies (e.g., tools, technologies, certifications) for a particular role. However, these preferred competencies can be extracted from the role description to determine if a particular role demands any specific competency along with a proficiency level explicitly. This can be performed using a customized Named Entity Recognition (NER) model that can identify preferred competencies associated with tools and technologies listed in a role description. Although not limited in this manner, the each competency can have one of 4 proficiency levels: 1 (basic understanding), 2 (working knowledge), 3 (extensive experience), and 4 (expert).

Referring to block 50, the machine learning engine is configured to identify similar role titles to the input role title. The approach for determining similarity can be the similarity approach described above with regard to block 35. By identifying similar role titles, it is possible to identify industry-recognized competencies for a particular role.

Referring to block 55, competencies are inferred from the similar role titles identified in block 30. This operation can use the data associated with the similar role titles found in talent frameworks (such as organizational talent frameworks 59A and/or third party talent frameworks 59B) to determine competencies associated therewith which are read in block 57.

Referring to block 60, competencies extracted in blocks 35, 45, and 55 are aggregated together as an aggregated collection of competencies. From this aggregated collection of competencies, a predetermined number of foundational and functional competencies are selected. This operation also involves ranking the competencies based upon competency type and competency class and the ranking can also be based upon job band level (hereinafter “band level”) requirement, job family, job family group.

A band level refers to a proficiency/competency for a particular job as a whole. For example, for senior band levels for an identical role, certain competencies may be needed at expert level, whereas for a lower band level, a competency may only be required at a basic understanding or working knowledge level. Also, as individuals move to leadership positions, there may be a greater emphasis on foundational competencies as opposed to functional competencies.

Accordingly, block 60 can include the following sub-operations of: i) applying deduplication to the aggregated collection of competencies and determining a frequency of the competencies in the aggregated collection, ii) assign priorities by source (e.g., in certain aspects, competencies from block 35 are assigned a medium priority, competencies from block 45 are assigned a low priority, and competencies from block 55 are assigned a high priority), iii) reorder competencies based upon priority, frequency, and aggregated similarity score, and (iv) adjust proficiency level based on band level and competency type. The aggregated similarity score can be calculated by aggregating similarity scores of a same competency at different proficiency levels. These competencies in the matrix of FIG. 2 can be sorted based upon their similarity score to return best matched competencies.

Example logic for adjusting proficiency levels in sub-operation (iv) is the following with the example presuming an organization with 5 band levels with 1 being the lowest and 5 being the highest:

If band level<3, check competency type. If competency type is part of [a, b, c], then check proficiency level. If proficiency level>3, then set proficiency level=3.

If band level=3, check competency type. If competency type is part of [a, b, c], then check proficiency level. If proficiency level>3, then set proficiency level=proficiency level −1 (i.e., reduce proficiency level by 1).

If band level>3, check competency type. If competency type is part of [a, b, c], then check proficiency level. If proficiency level>3, then set proficiency level=proficiency level −1 (i.e., reduce proficiency level by 1). Otherwise, if competency type is part of [d, e, f], then check proficiency level. If proficiency level>3, then set proficiency level=proficiency level.

Referring to block 70, based upon the order, a predetermined (and configurable) number of foundational and predetermined number of functional competencies are selected based a particular job family (hereinafter “family′). For example, for one family, 10 functional competencies and 8 foundational competencies may be selected, and for another family, 8 functional competencies and 12 foundational competencies may be selected. In certain aspects, the identified competencies and proficiency levels can be reviewed by one or more subject matter experts 75. The feedback provided by the one or more subject matter experts 75 can be used to validate/update the identified competencies and proficiency levels.

Referring to block 80, the roles in the role repository 10 are augmented with metadata. This metadata includes the selected plurality of competencies and the proficiency levels associated therewith.

As defined herein, the term “responsive to” means responding or reacting readily to an action or event. Thus, if a second action is performed “responsive to” a first action, there is a causal relationship between an occurrence of the first action and an occurrence of the second action, and the term “responsive to” indicates such causal relationship.

As defined herein, the term “real time” means a level of processing responsiveness that a user or system senses as sufficiently immediate for a particular process or determination to be made, or that enables the processor to keep up with some external process.

As defined herein, the term “automatically” means without user intervention.

Referring to FIG. 3, computing environment 300 contains an example of an environment for the execution of at least some of the computer code involved in performing the inventive methods, such as feature implementation system code block 350 for implementing the operations of the role augmentation system 150. Computing environment 300 includes, for example, computer 301, wide area network (WAN) 302, end user device (EUD) 303, remote server 304, public cloud 305, and private cloud 306. In certain aspects, computer 301 includes processor set 310 (including processing circuitry 320 and cache 321), communication fabric 311, volatile memory 312, persistent storage 313 (including operating system 322 and feature implementation system code block 350), peripheral device set 314 (including user interface (UI), device set 323, storage 324, and Internet of Things (IOT) sensor set 325), and network module 315. Remote server 304 includes remote database 330. Public cloud 305 includes gateway 340, cloud orchestration module 341, host physical machine set 342, virtual machine set 343, and container set 344.

Computer 301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 330. As is well understood in the art of computer technology, and depending upon the technology, performance of a computer-implemented method may be distributed among multiple computers and/or between multiple locations. However, to simplify this presentation of computing environment 300, detailed discussion is focused on a single computer, specifically computer 301. Computer 301 may or may not be located in a cloud, even though it is not shown in a cloud in FIG. 3 except to any extent as may be affirmatively indicated.

Processor set 310 includes one, or more, computer processors of any type now known or to be developed in the future. As defined herein, the term “processor” means at least one hardware circuit (e.g., an integrated circuit) configured to carry out instructions contained in program code. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller. Processing circuitry 320 may be distributed over multiple packages, for example, multiple, coordinated integrated circuit chips. Processing circuitry 320 may implement multiple processor threads and/or multiple processor cores. Cache 321 is memory that is located in the processor chip package(s) and is typically used for data or code that should be available for rapid access by the threads or cores running on processor set 310. Cache memories are typically organized into multiple levels depending upon relative proximity to the processing circuitry. Alternatively, some, or all, of the cache for the processor set may be located “off chip.” In certain computing environments, processor set 310 may be designed for working with qubits and performing quantum computing.

Computer readable program instructions are typically loaded onto computer 301 to cause a series of operational steps to be performed by processor set 310 of computer 301 and thereby effect a computer-implemented method, such that the instructions thus executed will instantiate the methods specified in flowcharts and/or narrative descriptions of computer-implemented methods discussed above in this document (collectively referred to as “the inventive methods”). These computer readable program instructions are stored in various types of computer readable storage media, such as cache 321 and the other storage media discussed below. The program instructions, and associated data, are accessed by processor set 310 to control and direct performance of the inventive methods. In computing environment 300, at least some of the instructions for performing the inventive methods may be stored in feature implementation system code block 350 in persistent storage 313.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Communication fabric 311 is the signal conduction paths that allow the various components of computer 301 to communicate with each other. Typically, this communication fabric 311 is made of switches and electrically conductive paths, such as the switches and electrically conductive paths that make up busses, bridges, physical input/output ports and the like. Other types of signal communication paths may be used for the communication fabric 311, such as fiber optic communication paths and/or wireless communication paths.

Volatile memory 312 is any type of volatile memory now known or to be developed in the future. Examples include dynamic type random access memory (RAM) or static type RAM. Typically, the volatile memory 312 is characterized by random access, but this is not required unless affirmatively indicated. In computer 301, the volatile memory 312 is located in a single package and is internal to computer 301. In addition to alternatively, the volatile memory 312 may be distributed over multiple packages and/or located externally with respect to computer 301.

Persistent storage 313 is any form of non-volatile storage for computers that is now known or to be developed in the future. The non-volatility of the persistent storage 313 means that the stored data is maintained regardless of whether power is being supplied to computer 301 and/or directly to persistent storage 313. Persistent storage 313 may be a read only memory (ROM), but typically at least a portion of the persistent storage 313 allows writing of data, deletion of data and re-writing of data. Some familiar forms of persistent storage 313 include magnetic disks and solid state storage devices. Operating system 322 may take several forms, such as various known proprietary operating systems or open source Portable Operating System Interface type operating systems that employ a kernel. The code included in feature implementation system code block 350 typically includes at least some of the computer code involved in performing the inventive methods.

Peripheral device set 314 includes the set of peripheral devices for computer 301. Data communication connections between the peripheral devices and the other components of computer 301 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet.

In various aspects, UI device set 323 may include components such as a display screen, speaker, microphone, wearable devices (such as goggles and smart watches), keyboard, mouse, printer, touchpad, game controllers, and haptic devices. Storage 324 is external storage, such as an external hard drive, or insertable storage, such as an SD card. Storage 324 may be persistent and/or volatile. In some aspects, storage 324 may take the form of a quantum computing storage device for storing data in the form of qubits. In aspects where computer 301 is required to have a large amount of storage (for example, where computer 301 locally stores and manages a large database) then this storage 324 may be provided by peripheral storage devices designed for storing very large amounts of data, such as a storage area network (SAN) that is shared by multiple, geographically distributed computers. Internet-of-Things (IOT) sensor set 325 is made up of sensors that can be used in IoT applications. For example, one sensor may be a thermometer and another sensor may be a motion detector.

Network module 315 is the collection of computer software, hardware, and firmware that allows computer 301 to communicate with other computers through a Wide Area Network (WAN) 302. Network module 315 may include hardware, such as modems or Wi-Fi signal transceivers, software for packetizing and/or de-packetizing data for communication network transmission, and/or web browser software for communicating data over the internet. In certain aspects, network control functions and network forwarding functions of network module 315 are performed on the same physical hardware device. In other aspects (for example, aspects that utilize software-defined networking (SDN)), the control functions and the forwarding functions of network module 315 are performed on physically separate devices, such that the control functions manage several different network hardware devices. Computer readable program instructions for performing the inventive methods can typically be downloaded to computer 301 from an external computer or external storage device through a network adapter card or network interface included in network module 315.

WAN 302 is any Wide Area Network (for example, the internet) capable of communicating computer data over non-local distances by any technology for communicating computer data, now known or to be developed in the future. In some aspects, the WAN 302 ay be replaced and/or supplemented by local area networks (LANs) designed to communicate data between devices located in a local area, such as a Wi-Fi network. The WAN 302 and/or LANs typically include computer hardware such as copper transmission cables, optical transmission fibers, wireless transmission, routers, firewalls, switches, gateway computers and edge servers.

End user device (EUD) 303 is any computer system that is used and controlled by an end user (for example, a customer of an enterprise that operates computer 301), and may take any of the forms discussed above in connection with computer 301. EUD 303 typically receives helpful and useful data from the operations of computer 301. For example, in a hypothetical case where computer 301 is designed to provide a recommendation to an end user, this recommendation would typically be communicated from network module 315 of computer 301 through WAN 302 to EUD 303. In this way, EUD 303 can display, or otherwise present, the recommendation to an end user. In certain aspects, EUD 303 may be a client device, such as thin client, heavy client, mainframe computer, desktop computer and so on.

As defined herein, the term “client device” means a data processing system that requests shared services from a server, and with which a user directly interacts. Examples of a client device include, but are not limited to, a workstation, a desktop computer, a computer terminal, a mobile computer, a laptop computer, a netbook computer, a tablet computer, a smart phone, a personal digital assistant, a smart watch, smart glasses, a gaming device, a set-top box, a smart television and the like. Network infrastructure, such as routers, firewalls, switches, access points and the like, are not client devices as the term “client device” is defined herein. As defined herein, the term “user” means a person (i.e., a human being).

Remote server 304 is any computer system that serves at least some data and/or functionality to computer 301. Remote server 304 may be controlled and used by the same entity that operates computer 301. Remote server 304 represents the machine(s) that collect and store helpful and useful data for use by other computers, such as computer 301. For example, in a hypothetical case where computer 301 is designed and programmed to provide a recommendation based on historical data, then this historical data may be provided to computer 301 from remote database 330 of remote server 304. As defined herein, the term “server” means a data processing system configured to share services with one or more other data processing systems.

Public cloud 305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 305 is performed by the computer hardware and/or software of cloud orchestration module 341. The computing resources provided by public cloud 305 are typically implemented by virtual computing environments that run on various computers making up the computers of host physical machine set 342, which is the universe of physical computers in and/or available to public cloud 305. The virtual computing environments (VCEs) typically take the form of virtual machines from virtual machine set 343 and/or containers from container set 344. It is understood that these VCEs may be stored as images and may be transferred among and between the various physical machine hosts, either as images or after instantiation of the VCE. Cloud orchestration module 341 manages the transfer and storage of images, deploys new instantiations of VCEs and manages active instantiations of VCE deployments. Gateway 340 is the collection of computer software, hardware, and firmware that allows public cloud 305 to communicate through WAN 302.

VCEs can be stored as “images,” and a new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 306 is similar to public cloud 305, except that the computing resources are only available for use by a single enterprise. While private cloud 306 is depicted as being in communication with WAN 302, in other aspects, a private cloud 306 may be disconnected from the internet entirely (e.g., WAN 302) and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this aspect, public cloud 305 and private cloud 306 are both part of a larger hybrid cloud.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

As another example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. Each block in the flowchart or block diagrams may represent a module, segment, or portion of instructions, which comprises one or more executable instructions for implementing the specified logical function(s).

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes,” “including.” “comprises,” and/or “comprising.” when used in this disclosure, specify the presence of stated features, integers, steps, operations, elements, and/or components, but do not preclude the presence or addition of one or more other features, integers, steps, operations, elements, components, and/or groups thereof. Reference throughout this disclosure to “one embodiment,” “an embodiment,” “one arrangement,” “an arrangement,” “one aspect,” “an aspect,” or similar language means that a particular feature, structure, or characteristic described in connection with the embodiment is included in at least one embodiment described within this disclosure. Thus, appearances of the phrases “one embodiment,” “an embodiment,” “one arrangement,” “an arrangement,” “one aspect,” “an aspect,” and similar language throughout this disclosure may, but do not necessarily, all refer to the same embodiment.

The term “plurality,” as used herein, is defined as two or more than two. The term “another,” as used herein, is defined as at least a second or more. The term “coupled,” as used herein, is defined as connected, whether directly without any intervening elements or indirectly with one or more intervening elements, unless otherwise indicated. Two elements also can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, etc. may be used herein to describe various elements, these elements should not be limited by these terms, as these terms are only used to distinguish one element from another unless stated otherwise or the context indicates otherwise.

The term “if” may be construed to mean “when” or “upon” or “in response to determining” or “in response to detecting.” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. As used herein, the terms “if,” “when.” “upon,” “in response to,” and the like are not to be construed as indicating a particular operation is optional. Rather, use of these terms indicate that a particular operation is conditional. For example and by way of a hypothetical, the language of “performing operation A upon B” does not indicate that operation A is optional. Rather, this language indicates that operation A is conditioned upon B occurring.

The foregoing description is just an example of embodiments of the invention, and variations and substitutions. While the disclosure concludes with claims defining novel features, it is believed that the various features described herein will be better understood from a consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

What is claimed is:

1. A computer-implemented method within a computer hardware system including a machine learning engine, comprising:
preprocessing text of a role description of a role having a role title;
inferring, using the machine learning engine, competencies from the role description;
identifying, in a talent framework and using the machine learning engine, competencies from role titles being similar to the role title;
aggregating the competencies into an aggregation of competencies;
ordering the competencies in the aggregation based upon aggregated similarity scores;
adjusting a proficiency level associated with each of the competencies in the aggregation based upon band level and competency type;
selecting a plurality of competencies; and
augmenting the role with metadata that includes the selected plurality of competencies and proficiency levels associated therewith.

2. The method of claim 1, wherein
the competencies include functional competencies and foundational competencies, and
the selecting the competencies includes selecting, for a particular family, a predetermined number of foundational competencies and a predetermined number of functional competencies.

3. The method of claim 1, wherein
the inferring the competences from the role description includes
mapping the text of the role description to classes,
filtering the text of the role description based upon the mapping,
converting the text of the role description to a vector representation, and
performing a similarity analysis using the vector representation to determine one or more competencies that correspond to the role description.

4. The method of claim 3, wherein
the similarity analysis employs a cosine similarity analysis for vectors A and B using the following equation:
$$similarity = cos ( θ ) = \frac{A \cdot B}{‖ A ‖ ‖ B ‖} = \frac{{\sum }_{i = 1}^{n} {A}_{i} {B}_{i}}{\sqrt{{\sum }_{i = 1}^{n} {A}_{i}^{2}} \sqrt{{\sum }_{i = 1}^{n} {B}_{i}^{2}}} ,$$
wherein Ai and Bi are components of the vectors A and B, and
the vector A represents the text of the role description and the vector B represents a particular competency.

5. The method of claim 1, further comprising extracting, using the machine learning engine, preferred competencies from the text of the role description.

6. The method of claim 5, wherein
a prioritization of the competencies in the aggregation is performed based upon source,
the competencies from the extracting the preferred competencies having a higher priority than the competencies from the inferring the competencies from the role description,
the competencies from identifying the competencies from the titles in the talent framework having a lower priority from the inferring the competencies from the role description, and
the selecting the plurality of competencies is based upon the prioritization.

7. The method of claim 1, wherein
the preprocessing the text of a role description includes:
removing, using natural language processing, organization text, and
standardizing the role title.

8. A computer hardware system including a machine learning engine, comprising:
a hardware processor configured to perform the following executable operations:
preprocessing text of a role description of a role having a role title;
inferring, using the machine learning engine, competencies from the role description;
identifying, in a talent framework and using the machine learning engine, competencies from role titles being similar to the role title;
aggregating the competencies into an aggregation of competencies;
ordering the competencies in the aggregation based upon aggregated similarity scores;
adjusting a proficiency level associated with each of the competencies in the aggregation based upon band level and competency type;
selecting a plurality of competencies; and
augmenting the role with metadata that includes the selected plurality of competencies and proficiency levels associated therewith.

9. The system of claim 8, wherein
the competencies include functional competencies and foundational competencies, and
the selecting the competencies includes selecting, for a particular family, a predetermined number of foundational competencies and a predetermined number of functional competencies.

10. The system of claim 8, wherein
the inferring the competences from the role description includes
mapping the text of the role description to classes,
filtering the text of the role description based upon the mapping,
converting the text of the role description to a vector representation, and
performing a similarity analysis using the vector representation to determine one or more competencies that correspond to the role description.

11. The system of claim 10, wherein
the similarity analysis employs a cosine similarity analysis for vectors A and B using the following equation:
$$similarity = cos ( θ ) = \frac{A \cdot B}{‖ A ‖ ‖ B ‖} = \frac{{\sum }_{i = 1}^{n} {A}_{i} {B}_{i}}{\sqrt{{\sum }_{i = 1}^{n} {A}_{i}^{2}} \sqrt{{\sum }_{i = 1}^{n} {B}_{i}^{2}}} ,$$
wherein Ai and Bi are components of the vectors A and B, and
the vector A represents the text of the role description and the vector B represents a particular competency.

12. The system of claim 8, further comprising
extracting, using the machine learning engine, preferred competencies from the text of the role description.

13. The system of claim 12, wherein
a prioritization of the competencies in the aggregation is performed based upon source,
the competencies from the extracting the preferred competencies having a higher priority than the competencies from the inferring the competencies from the role description,
the competencies from identifying the competencies from the titles in the talent framework having a lower priority from the inferring the competencies from the role description, and
the selecting the plurality of competencies is based upon the prioritization.

14. The system of claim 8, wherein
the preprocessing the text of a role description includes:
removing, using natural language processing, organization text, and
standardizing the role title.

15. A computer program product, comprising:
a computer readable storage medium having stored therein program code,
the program code, which when executed by the computer hardware system including a machine learning engine, cause the computer hardware system to perform:
preprocessing text of a role description of a role having a role title;
inferring, using the machine learning engine, competencies from the role description;
identifying, in a talent framework and using the machine learning engine, competencies from role titles being similar to the role title;
aggregating the competencies into an aggregation of competencies;
ordering the competencies in the aggregation based upon aggregated similarity scores;
adjusting a proficiency level associated with each of the competencies in the aggregation based upon band level and competency type;
selecting a plurality of competencies; and
augmenting the role with metadata that includes the selected plurality of competencies and proficiency levels associated therewith.

16. The computer program product of claim 15, wherein
the competencies include functional competencies and foundational competencies, and
the selecting the competencies includes selecting, for a particular family, a predetermined number of foundational competencies and a predetermined number of functional competencies.

17. The computer program product of claim 15, wherein
the inferring the competences from the role description includes
mapping the text of the role description to classes,
filtering the text of the role description based upon the mapping,
converting the text of the role description to a vector representation, and
performing a similarity analysis using the vector representation to determine one or more competencies that correspond to the role description.

18. The computer program product of claim 17, wherein
the similarity analysis employs a cosine similarity analysis for vectors A and B using the following equation:
$$similarity = cos ( θ ) = \frac{A \cdot B}{‖ A ‖ ‖ B ‖} = \frac{{\sum }_{i = 1}^{n} {A}_{i} {B}_{i}}{\sqrt{{\sum }_{i = 1}^{n} {A}_{i}^{2}} \sqrt{{\sum }_{i = 1}^{n} {B}_{i}^{2}}} ,$$
wherein Ai and Bi are components of the vectors A and B, and
the vector A represents the text of the role description and the vector B represents a particular competency.

19. The computer program product of claim 15, further comprising
extracting, using the machine learning engine, preferred competencies from the text of the role description.

20. The computer program product of claim 19, wherein
a prioritization of the competencies in the aggregation is performed based upon source,
the competencies from the extracting the preferred competencies having a higher priority than the competencies from the inferring the competencies from the role description,
the competencies from identifying the competencies from the titles in the talent framework having a lower priority from the inferring the competencies from the role description, and
the selecting the plurality of competencies is based upon the prioritization.
